(19) United States
(12) Patent Application Publication
(10) Pub. No.: US 2004/0022278 A1
(43) Pub. Date: Feb. 5, 2004

(54) Localization and targeting of data in broadcast streams

(76) Inventors: Charles Gomer Thomas, Piscataway, NJ (US); David Catapano, Langhorne, PA (US); Dinkar Bhat, Monmouth Jct., NJ (US); Nagaraj Nandhakumar, Pennington, NJ (US)

Correspondence Address: BIRCH STEWART KOLASCH & BIRCH, PO BOX 747, FALLS CHURCH, VA, 22040-0747, US

(21) Appl. No.: 10/375,103

(22) Filed: Feb. 28, 2003

Related U.S. Application Data
(60) Provisional application No. 60/359,984, filed on Feb. 28, 2002.

(51) Int. Cl. H04J 3/02

(52) U.S. Cl. 370/537

(57) ABSTRACT

A method of providing localized data includes receiving, at least one of a plurality of local broadcast sites, a broadcast stream carrying global data; and inserting, at least one of local broadcast sites, localized data associated with the one of local broadcast sites into the received broadcast stream, so as to generate a modified broadcast stream carrying the global data and the localized data at the local broadcast site. A method of providing targeted data includes receiving a broadcast including a plurality of content streams, each of the content streams carrying targeted content data having certain targeting attributes; and selecting, by a selection device, one of the content streams based on the targeting attributes and attributes of a receiving party serviced by the selection device.

The present application claims the priority benefit of U.S. Provisional Application No. 60/359,984 filed on Feb. 28, 2002 and entitled “Localization and Targeting of Data in Broadcast Streams”, the entire contents of which are herein fully incorporated by reference.

### BACKGROUND OF THE INVENTION

Television and other types of broadcast media are effective for distributing entertainment and information to large numbers of recipients simultaneously. An increasingly common format for such entertainment and information is a video program with accompanying data, in a form that allows recipients with suitable receiving equipment to invoke selective displays of the data interactively, in order to augment the video pictures and enhance the entertainment or information value. Such a format is often called “data-enhanced video.” It is also increasingly common to have broadcast “programs” in which only data is broadcast (“stand-alone data program”), in a form that allows recipients with suitable receiving equipment to invoke selective displays of the data and achieve an interactive viewing experience. Data broadcast in this way, with or without video, are called “enhancements” or “enhancement content.”

In many situations it is desirable or even essential to have variations in the enhancements that are sent to different groups of recipients, instead of having all the recipients of the broadcast receive exactly the same enhancements. For example, a national TV network may distribute enhanced video programs to multiple local affiliates, which in turn broadcast them to their local viewing areas, and it may be desirable for some of the enhancements to be tailored to each local viewing audience. In another example, a corporation may distribute enhanced video programs for educational or corporate communication purposes to multiple branch offices, which in turn broadcast them to the individual employees in the branches, and it may be essential for some of the enhancements to be customized for each individual branch office. In still another example, a TV broadcaster may be broadcasting commercials which contain data enhancements, and it may be very profitable to target the commercials by customizing the enhancements for different classes of viewers, based on their geographical location or demographic characteristics or personal preferences.

The known mechanisms for data-enhanced broadcast video programs or stand-alone data broadcast programs, however, do not support such variations in the data that are sent to different groups of recipients. Rather, in the conventional systems, the same enhancements and contents are delivered to all receivers in the network. Thus, the conventional systems do not provide targeted enhancements and contents.

A number of different mechanisms have been developed for carrying enhancement contents in television broadcasts, either accompanying a video program or as a stand-alone data program, such that the data can be displayed interactively by recipients with suitable TV receivers. Some of these are proprietary, such as systems by Wink Communications, Inc., or OpenTV, Inc. Some are open standards, such as the ATVEF specification (currently being revised and issued as a standard by SMPTE, the Society of Moving Picture and Television Engineers), MHP (the Multimedia Home Platform, issued by DVB, the Digital Video Broadcasting Project), OCAP (the OpenCable Application Platform), and DASE (the DTV Application Software Environment standard under development by ATSC, the Advanced Television Systems Committee). There is also a well known set of “IP Multicast” standards for broadcasting data in IP (Internet Protocol) networks.

As known, an ATSC DTV broadcast stream may contain multiple virtual channels. Some may be video channels, each containing a video stream, one or more audio streams (possibly in different languages), and possibly some data streams. Some may be audio channels, each containing one or more audio streams and possibly some data streams. Some may be data channels, containing only data streams. The DTV broadcast stream also contains collections of “tables” that provide metadata (data describing data) telling receivers what is in the broadcast stream.

The video, audio, or data streams and the collections of tables each includes a sequence of 188-byte MPEG2 transport stream packets. Each packet has a header (e.g., 4-byte header) that contains certain information about the packet, including a PID (packet identification)(e.g., 13-bit PID) that is used to identify which video, audio, or data stream, or which collection of tables, the packet belongs to. These multiple sequences of transport stream packets are merged together to form the entire broadcast stream. DTV receivers can use the PIDs to sort out the sequences of transport stream packets as they arrive, and thereby recover any individual video, audio, or data stream, or any individual collection of tables.

One specific table that helps receivers identify what is in any MPEG-2 based DTV broadcast stream is the MPEG-2 Program Association Table, or PAT. The MPEG-2 standard specifies that transport stream packets carrying the PAT must have PID 0x0000, so that receivers always know how to find them. The PAT contains a list of all the virtual channels in the broadcast stream, and for each virtual channel it gives the PID of the transport stream packets carrying another table called a Program Map Table (PMT), for that virtual channel. Each PMT contains a list of all the program elements (video streams, audio streams, and/or data streams) in its virtual channel, gives the PIDs for the transport stream packets carrying each program element, and for each PID, it gives the “stream_type” of the program element. Thus, by means of these tables a receiver can find the audio, video and data streams for every virtual channel in the broadcast stream. It should be noted that the term “PID” is often used to refer to a program element consisting of the sequence of transport stream packets with a common PID value, as in “The Spanish language audio is in PID N.”

As known, in an ATSC DTV broadcast stream there is another table called the Virtual Channel Table, or VCT, which contains a combination of the information in the PAT and the information in all the PMTs. The ATSC PSIP standard specifies that transport stream packets carrying the VCT must have PID 0x1FFB, so receivers always know how to find them.

As is well known, under the ATVEF specification, the following three classes of data are available to receivers:

1. “Announcements” tell the receiver that data enhancements are present, give the IP addresses and ports of the enhancements in the broadcast stream, and describe their properties.

2. “Triggers” tell the receiver to take certain actions affecting the data display at certain times.

3. “Enhancements” or “enhancement content” provide the data that are actually to be displayed.

The announcements and triggers are generally delivered in the broadcast stream. The enhancement content may be delivered in the broadcast stream (Transport B) or may be retrieved by the receiver over a 2-way communications link (Transport A). For the purpose of describing the present invention, the focus is on the first case, where the enhancement content is delivered in the broadcast stream along with the announcements and triggers. However, the principles of the invention are applicable to the other case as well.

In an ATSC DTV broadcast stream, the announcements, triggers and enhancement content are generally all carried in IP packets, that are in turn encapsulated in so-called “addressable sections,” and then packed into MPEG2 transport stream packets, as specified in the ATSC Data Broadcast Standard. The PMT for the virtual channel uses stream_type 0x0D to label each PID containing addressable sections.

An ATVEF announcement is in the form of an SDP (Session Description Protocol) announcement, as specified in IETF RFC 2327, that is encapsulated in an SAP (Session Announcement Protocol) message, as specified in IETF RFC 2974. Each announcement is carried in an IP Multicast packet, with a specified destination IP address and UDP port reserved for ATVEF announcements. They convey such information as the session name and identifier, the session start and stop time, bandwidth used by the session, the amount of cache space in the receiver required to handle the enhancements for the session, the destination IP addresses and UDP ports for the triggers and the enhancement content for the session, and an optional “type:tve” parameter that can be used to distinguish the nature of the session (where “session” in this situation refers to a sequence of enhancements for a single program).

An ATVEF trigger is a message that contains a URL and optionally a name and/or a script string (representing an ECMAscript command). When a trigger with a name arrives, the receiver should display the page referenced in the URL, unless it is already displayed. If the trigger also has a script, the receiver should execute the script on the page after it displays the page. Of course, if the receiver cannot find the page referenced in the URL, it should ignore the trigger. If a trigger with a script string arrives, and if the URL of the trigger matches the URL of the page currently being displayed, the receiver should execute the script string on the displayed page. If the trigger does not have a name, and if the URL does not match the URL of the currently displayed page, the receiver should ignore it. Each trigger is contained in a single IP packet.

ATVEF enhancement content includes files containing HTML pages and associated components, such as frames, images, etc. Each file has a header that contains an identifying URL and other information. The file together with its header is divided into blocks and packed into a sequence of IP packets using UHTTP (Unidirectional HTTP) encapsulation, as defined in the ATVEF specification.

Thus, when an ATVEF-capable receiver is tuned to an ATSC DTV channel that contains ATVEF enhancements, it goes through the following steps:

1. If a Virtual Channel Table (VCT) is present, as it should be, the receiver looks in the VCT to identify the PIDs and the types of the video, audio, and/or data streams that make up the virtual channel. It routes the desired video and audio streams, if any, to the video and audio decoders. It routes all data streams that are identified in the VCT as containing addressable sections with IP packets in them to its ATVEF processor.

2. If there is no VCT present, then the receiver looks in the Program Map Table (PMT) for the virtual channel to identify the PIDs and the types of the video, audio, and/or data streams that make up the virtual channel and proceeds as in (1).

3. The ATVEF processor extracts the addressable sections from the transport stream packets, then extracts the IP packets from the addressable sections.

4. Initially the ATVEF processor looks only for IP packets addressed to the IP address and port designated for ATVEF announcements. As soon as it receives one, it picks out of it the parameters for the ATVEF session, including the addresses and ports where the triggers and content can be found. From then on it looks for IP packets containing triggers and content, as well as IP packets containing announcements.

5. As IP packets containing content files are received, each file is reconstructed and stored in cache, along with the identifying URL from the file header.

6. When an IP packet containing a named trigger arrives, the URL in the trigger is compared to the identifying URLs of the files in cache. If a match is found, the corresponding file is displayed (together with its components—frames, images, etc.). Otherwise the trigger is ignored.

7. When an IP packet containing an unnamed trigger arrives, the URL in the trigger is compared to the identifying URL of the top-level page currently being displayed. If the URLs match, the script in the trigger is executed. Otherwise the trigger is ignored.

Many other data broadcast protocols have the property that announcements appear in well-known locations in the broadcast stream, and receivers use these announcements to locate the data. It is not unusual to have multiple levels of announcements, where the top level announcements are in a well-known location, these indicate where the next lower level announcements can be found, and so on until some lower level finally indicates where the data can be found.

In a conventional art, a virtual channel being broadcast with ATVEF data in it delivers the same announcements, triggers, and content to all receivers, so that they all provide their viewers access to exactly the same viewing experience. However, in the present invention, different individuals or groups of recipients will be able to view more targeted information based on various factors.

### SUMMARY OF THE INVENTION

Particularly, the present invention solves these and other problems by providing convenient and efficient mechanisms to deliver different data to different groups of recipients in the context of a single broadcast program.

The present invention provides methods for effectively delivering different data to different groups of receivers receiving the same broadcast, so that they provide their viewers with different viewing experiences. The selection of which receivers receive which data may be based on the geographic location, demographic characteristics, or personal preferences of the viewers.

According to the present invention, one method is designed for a situation where at some stage of the production/distribution/broadcast process the communications path carrying the broadcast stream branches into multiple different paths that carry the broadcast stream to multiple different groups of viewers. This method inserts any data aimed at all viewers into the broadcast stream at some stage before the path branches, and then at a later stage of the process, after the path branches, inserts additional data aimed only at individual groups of viewers into the broadcast streams in the different paths. This method will be referred to as the “global/local insertion” method. The novelty of this method lies in part with the overall concept of this approach, and in part from the techniques that insure the insertion of the additional data at the later stage does not cause any data conflicts or discontinuities when merged with the initial data stream.

The key idea behind the insertion techniques of the present invention is that it is easier to merge the actual content than it is to merge the announcements and triggers—i.e., the signaling information that tells the receiver where the data is and how to display it. Therefore, the announcements and triggers are all inserted at the earlier stage, along with the content that is aimed at all receivers, and only additional content aimed at individual groups of receivers is inserted at the later stage, not additional announcements or triggers. This also has the advantage that the timing of the enhancements is determined uniformly by the original content creator, and only the content of some of the individual enhancements is allowed to be varied at the later stage.

A straightforward variation on the technique could be used to allow triggering to be varied at the later stage, but care would have to be taken with the timing, to make sure that the triggers inserted later would not interfere with the triggers inserted earlier.

According to the present invention, another method is designed for a situation where the broadcast stream reaching the receivers always carries multiple sets of data, the same sets for all receivers, but various parameters in the broadcast stream are used to signal to each receiver what set of data it should actually present to the viewer, depending on the geographical location of the receiver or the viewer's preferences or demographic characteristics. This method will be referred to as the “receiver selection” method. The novelty of this method lies in part with the overall concept of this approach, and in part from the techniques that allow the parameters to signal to the receivers what data to present, without undesirable side effects. . For example, usually standard receivers need to be modified slightly in order for this method to work. It is important that this modification be easy to accomplish, and in the situation where unmodified receivers may be receiving the broadcast it is often important that the use of the parameters to signal the modified target receivers does not interfere with the correct operation of unmodified receivers.

Of course, these two methods of the present invention can be used in combination. For instance, different data can be inserted into the broadcast streams in different paths going to different groups of receivers, in such a way that each path ends up with multiple sets of data (typically different data for different paths) aimed at different subgroups of receivers within the group receiving the broadcast stream in that path, with parameters in the broadcast stream used to signal to each subgroup what set it should use.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows a high level view of a system embodying the global/local insertion method according an embodiment of to the present invention.

FIG. 2 is a diagram of a data insertion system usable in the system of FIG. 1, operating in the context of an MPEG-2 broadcast stream, according to an embodiment of the present invention.

FIG. 3 is a diagram of a data insertion system usable in the system of FIG. 1, operating in the context of an IP network broadcast, according to another embodiment of the present invention.

FIG. 4A shows an example of a record in a scheduling metadata storage according to an embodiment of the present invention.

FIG. 4B shows an example of the program logic usable by a stored program computer in a data insertion system such as could be used in the system of FIG. 1 according to an embodiment of the present invention.

FIG. 5 shows a high level view of a system using the global/local insertion method according to an embodiment of the present invention, in the special case where a national TV network is distributing interactive TV programming to local stations, and the local stations are in turn broadcasting the programming to viewers in their homes.

FIG. 6 shows pictorially a possible arrangement for inserting announcements, triggers, and global and local content into transport stream packets of an MPEG-2 transport stream, whereby the local content augments the global content, according to the global/local insertion method of the present invention.

FIG. 7 shows pictorially another possible arrangement for inserting announcements, triggers and global and local content into a digital television broadcast stream, whereby the local content replaces some of the global content, according to the global/local insertion method of the present invention.

FIG. 8 illustrates how an SDP session description can be encapsulated into an SDP/SAP session announcement and then into an IP packet, according to known IETF SDP, SAP, UDP and IP standards.

FIG. 9 illustrates how an IP packet can be encapsulated into an addressable section and then into a sequence of MPEG-2 transport stream packets, and how the MPEG-2 transport stream packets can then be multiplexed into an MPEG-2 transport stream, according to known ATSC Data Broadcast Standard and known MPEG-2 Systems Standard.

FIG. 10 illustrates how a content file can be prefixed with an HTTP-like header, then divided into blocks, and how each block can then be prefixed with an UHTTP header and encapsulated into an IP packet, according to known SMPTE UHTTP standard and known IETF UDP and IP standards.

FIG. 11 illustrates a general problem that is solved by the receiver selection method of the present invention, wherein a broadcast site is sending out multiple versions of a data enhancement, each with some associated targeting attribute values, and each user site is supposed to select the version that is best suited to the attribute values of the user at that site.

FIG. 12 shows a high level view of a system embodying the receiver selection method according to an embodiment of the present invention.

FIG. 13 illustrates one way in which the fields in the MPEG-2 Program Map Table (PMT) could be used to support the receiver selection method according to an embodiment of the present invention, in the context of an MPEG-2 broadcast stream.

FIG. 14 illustrates one way in which the fields in an SDP/SAP announcement could be used to support the receiver selection method according to another embodiment of the present invention, in the context of IP multicast broadcasts.

FIG. 15 illustrates one way in which the fields of separate SDP/SAP announcements could be used to support the receiver selection method according to another embodiment of the present invention, in the context of IP multicast broadcasts.

FIG. 16 illustrates one way in which the fields of UHTTP file headers could be used to support the receiver selection method according to another embodiment of the present invention, in the context of the SMPTE Declarative Data Essence standards, or other data broadcasts using similar file headers.

FIG. 17A shows an example of a program logic usable by a data selection device such as that shown in FIG. 9, in order to select content on the basis of targeting parameter values appearing in announcements in the broadcast stream according to an embodiment of the present invention.

FIG. 17B shows an example of a program logic usable by a data selection device such as that shown in FIG. 9, in order to select content on the basis of targeting parameter values appearing in content file headers in the broadcast stream according to an embodiment of the present invention.

### DETAILED DISCUSSION OF THE PREFERRED EMBODIMENTS

1. Localization of Data

Many TV programs originate with a broadcast or cable network, which distributes them via satellite feed to local terrestrial TV stations or local cable TV head-ends, which then broadcast them over the air or over the cable system. In some cases the distribution is in the form of an MPEG-2 transport stream, containing one or more virtual channels all ready to broadcast.

When ATVEF data enhancements are being used in such a situation, the present invention can use the following method to provide, within a single virtual channel, a combination of common enhancements and localized enhancements for viewers in different local viewing areas:

Two PIDs (program elements), N1 and N2, are used to carry data. The VCT and PMT for the virtual channel is generated at the central origination point (at the network level) and signals the presence of the two data PIDs (as well as whatever video and audio PIDs are present). The common data is inserted at the central origination point into PID N1, while local data may be inserted at each local station or head-end into PID N2.

This arrangement of putting the data from the two different sources into two different PIDs prevents invalid transport stream packet interleaving or invalid discontinuities in the continuity_counter field in the headers of the transport stream packets within a single PID. Each IP packet in an addressable section is typically segmented into multiple transport stream packets. These must appear in the PID in sequence in order for the receiver to reconstruct them. If two sets of data from two different sources are being inserted into the same PID at different times, then it is very difficult to prevent the transport stream packets carrying different IP packets from being interleaved with each other. If this happens, then receivers can no longer reconstruct the IP packets. Also, according to the MPEG-2 standard, the continuity_counter fields in the transport stream packet headers are supposed to be incremented by 1 (modulo 15) in successive transport stream packets within the same PID. The interleaving of transport stream packets from two different sources within the same PID would create discontinuities in the continuity_counter fields. Such discontinuities lead receivers to believe that transport stream packets have been lost, so they may not process the data properly. There is MPEG-2 multiplexing equipment that is designed to merge MPEG-2 streams from different sources, but they are generally designed to merge different PIDs together, not merge different streams of transport stream packets within a single PID.

All announcements and triggers are part of the common data inserted at the central originating point, including the triggers that refer to data inserted at local stations or cable head-ends. Thus, the triggers in effect create a number of time slots for data content. Some of those time slots are filled with common content inserted at the central origination point. I.e., common content labeled with the appropriate URLs for those triggers are inserted into the content stream at the right times. The remainder of these slots are reserved for localized content to be inserted at the individual local stations or cable head-ends. All the local station or cable head-end needs to know to make this work is the times at which the local content is to be inserted (i.e., the times when the triggers will appear that are intended for the local content) and the URL that is to be used to label the content page associated with each trigger.

If a particular local station or cable operator chooses not to insert any local content, the effect is that the viewers in that area will see no enhancements during the time slots reserved for local content. The triggers will still appear in the broadcast stream, but since there are no content pages with the corresponding URLs, the receivers will just ignore the triggers.

A slight variation on this approach according to the present invention is to insert at the origination point common content with the proper URL labels into a third PID, N3, for the time slots designated for local content. If a local station or cable head-end chose not to insert local content, this common content would appear. If a local station or cable head-end wants to insert local content, it would have its multiplexer filter out PID N3 at the same time as it is inserting local content into PID N2. This would mean that viewers in all areas would see enhancements during all the time slots. The viewers in some areas would see localized enhancements during some of the time slots, while viewers in other areas would see only common enhancements all the time.

Also, it would be possible to insert only triggers and content for the common enhancements into PID N1 at the origination point, and to have the local stations or head ends insert both triggers and content for the localized enhancements into PID N2. However, this would be more prone to errors arising from the insertion of the local content. When all triggers are inserted at the point of origination, then any local content inserted at the wrong time would just be ignored, since its URLs would not match the triggers active at the time of its insertion. However, if both triggers and content are inserted at the local level, then inserting them at the wrong time would interfere with the common triggers and content.

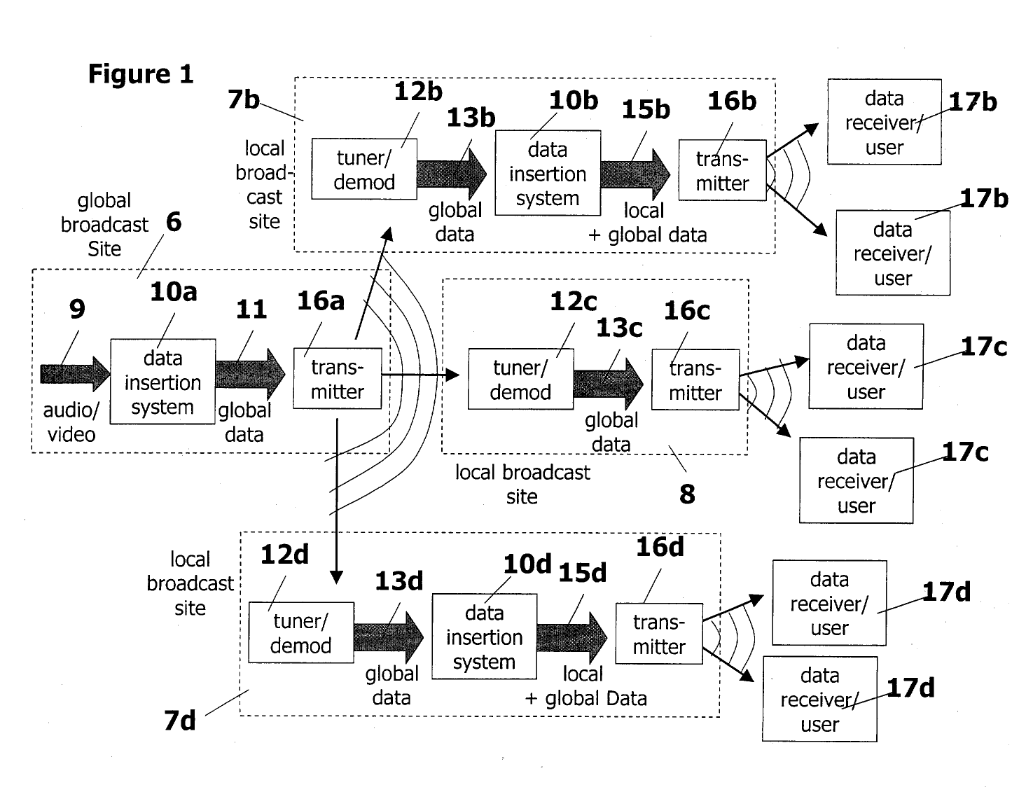

An example of a system that embodies this method is shown in FIG. 1. There is a global broadcast site 6. A digital stream 9 containing audio/video may be generated at this site. A data insertion system 10a at this site generates a data stream, which may be combined with an audio/video stream to produce a digital stream 11 with global data as well as audio/video. This digital stream 11 goes to a Transmitter 16a, where it is broadcast. There are local broadcast sites such as 7b, 8, 7d that can receive this broadcast. Some of these local broadcast sites, such as 8, will simply receive the broadcast with a tuner/demodulator (tuner/demod) device 12c, pass the digital stream 13c on through to a transmitter 16c, and broadcast it unchanged to data receiver/user devices 17c. Other local broadcast sites, such as 7b, 7d, will receive the broadcast with a tuner/demod device 12b, 12d, pass the digital stream 13b, 13d on through to another data insertion system 10b, 10d, where local data is inserted. The augmented digital stream 15b, 15d will then be sent to a transmitter 16b, 16d, where it is broadcast to data receiver/user devices 17b, 17d.

Transmitters 16a, 16b, 16c, 16d and tuner/demod devices 12b, 12c, 12d are standard commercial devices that are widely available for many different broadcast environments. The data receiver/user devices could be personal computers with software capable of rendering whatever type of data is being sent (for example, Flash or QuickTime animation, or ATVEF-compliant content).

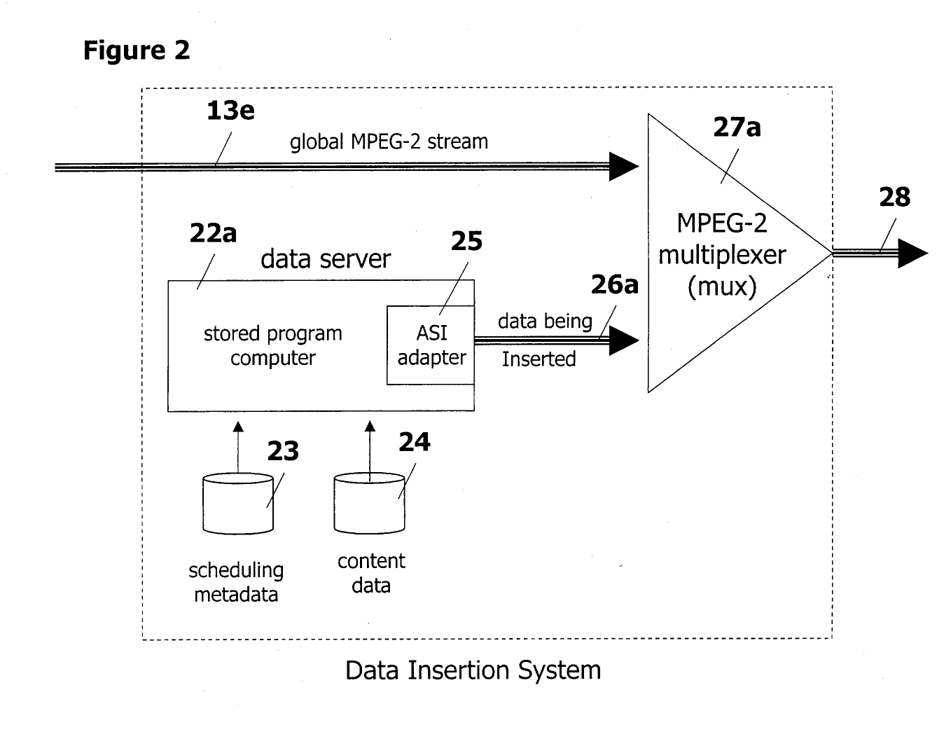

FIG. 2 shows an embodiment of a data insertion system such as 10a, 10b, 10d for use in an MPEG-2 broadcast environment (such as digital television). It contains a data server 22a that can output data through an ASI adapter 25 in the form of a stream of MPEG-2 transport stream packets 26a, that can be fed to an MPEG-2 multiplexer 27a, where they can be combined with an incoming MPEG-2 transport stream 21 to form an output MPEG-2 transport stream 28. The data server can consist of a stored program computer, such as a PC manufactured by Dell, Gateway, Hewlett-Packard and many other vendors, running an operating system such as Windows or Linux. Suitable ASI adapters are available from Linear Systems, Optibase, and other vendors. The data server 22a can have access to data storage devices where scheduling metadata 23 and content data 24 can be stored.

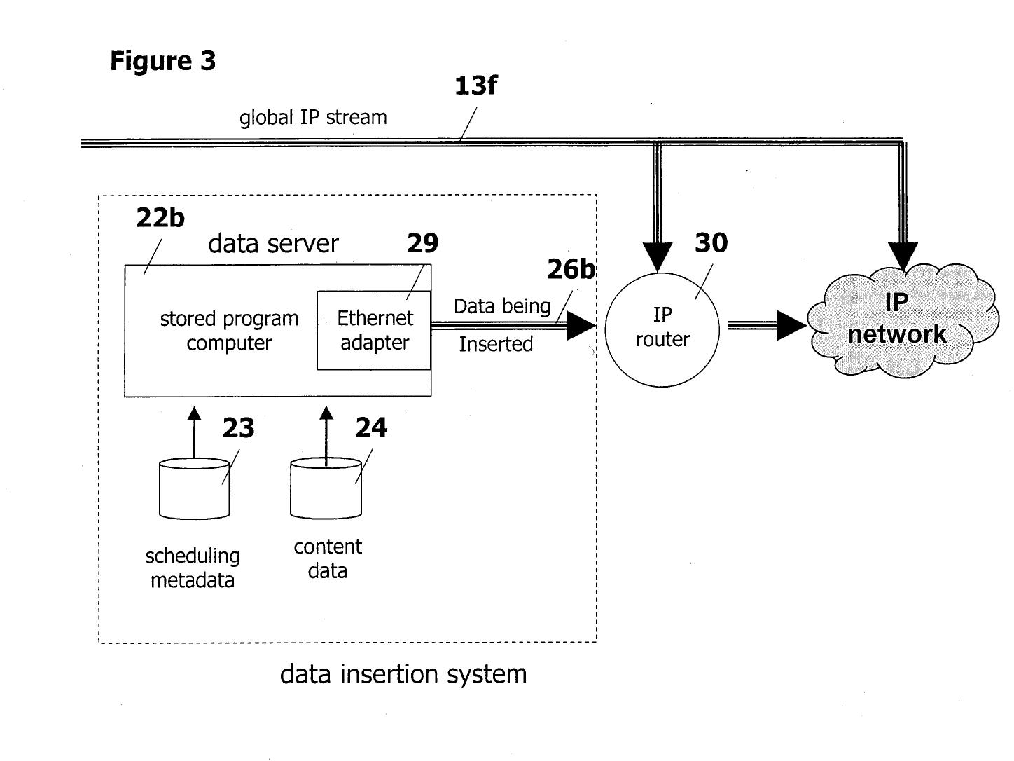

FIG. 3 shows an embodiment of a data insertion system such as 10a, 10b, 10d for use in an IP broadcast environment. It contains a data server 22b that can output data through an Ethernet adapter 29 in the form of a stream of IP packets 26b, that can be fed to an IP Router 30, which can play the role of a transmitter and send the stream out over an IP network. The data server 22b, complete with Ethernet adapter, can consist of a stored program computer, such as a PC manufactured by Dell, Gateway, Hewlett-Packard and many other vendors, running an operating system such as Windows or Linux. The data server 22b can have access to data storage devices where scheduling metadata 23 and content data 24 can be stored.

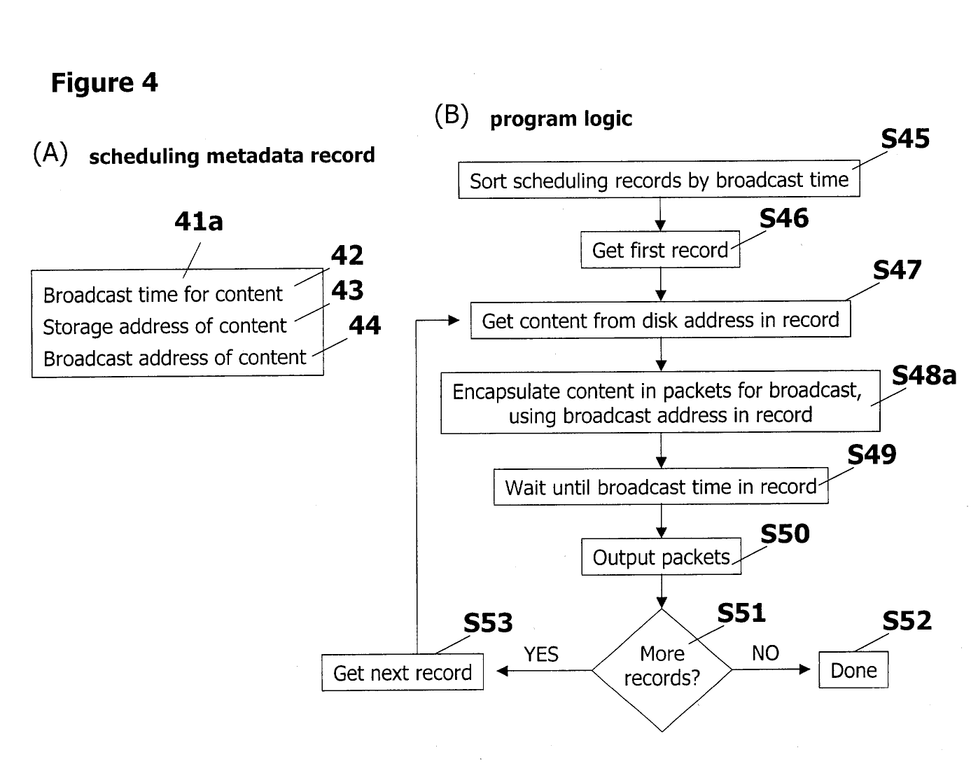

FIG. 4A shows a possible layout of the metadata records in such scheduling metadata 23. Each record 41a can contain the information needed for broadcast one content item (data item). A “broadcast time for content” field 42 tells when the content item should be broadcast. A “storage address for content” field 43 tells where the content item is currently located. A “broadcast address of content” field 44 tells how the broadcast packets containing the content should be addressed. For an MPEG-2 broadcast this field could tell the PID value that should appear in the header of the MPEG-2 transport stream packets that contain this content. For an IP broadcast (via IP multicast, for example), this field could tell the IP address and UDP port that should appear in the UDP/IP header of the IP packets that contain this content.

FIG. 4B shows an example of the program logic that could be used in a data server 22a, 22b to output a collection of content items according to the schedule in the scheduling metadata 23. In the first step S45 it could sort the scheduling records in order of ascending broadcast time 42 of the records. In the next step S46 it could get the first record in the sorted list. In the next step S47 it could get the content from the storage address 43 given in the record. In the next step S48 it could encapsulate the content in packets for broadcast, according to whatever data broadcast standard is being used, using the broadcast address 44 of the record to address the packets. In the next step S49 it could wait until the broadcast time 42 specified in the record. In the next step S50 it could output the packets. In the next step S51 it could check whether there are any more records in the sorted list of scheduling metadata. If there are no more records, it is done S52. If there are more records, the next step S53 could be to get the next record in the list, and then return to step S47.

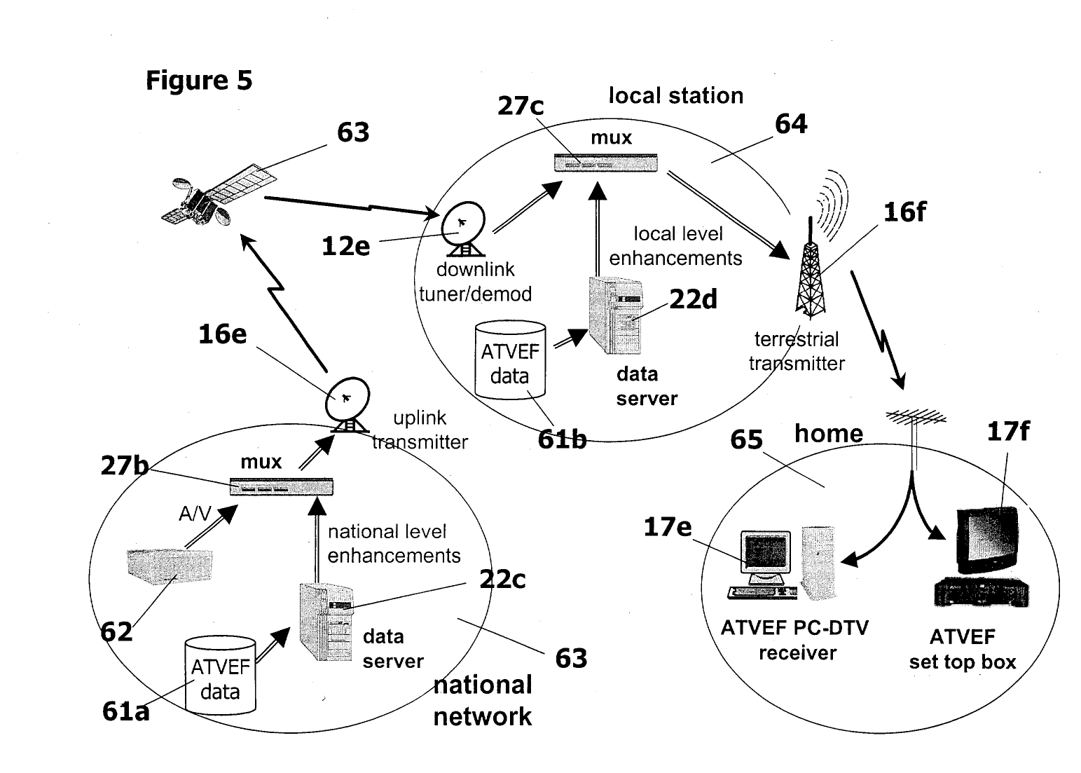

FIG. 5 illustrates a specific example of how this system could be used in the context of a national television network broadcasting programming with ATVEF enhancements, and allowing some of the local affiliates of the network to insert additional local ATVEF enhancements. The ATVEF Data 61a, 61b contains both scheduling metadata 23 and content data 24. There is an audio/video server 62 at the national network 63 that generates an audio/video stream. This is combined in a multiplexer 27b with a data stream from a data server 22c to form a broadcast stream that is transmitted to each affiliated local station 64 via satellite 63. If the local station wants to insert additional local enhancements, it uses its own data server 22d to generate a data stream, which is combined with the network broadcast stream in a multiplexer 27c. This combined stream is then broadcast locally with a television transmitter 16f. If a viewer has a data receiver/user device 17e, 17f that is ATVEF compatible, then the viewer can see both the national and local enhancements.

A needed consideration when using this method in a digital television environment is making sure that the local enhancements do not interfere with the global enhancements. The structure of an MPEG-2 transport stream (which is used for digital television), is such that putting additional data into transport stream packets with the same PID value in their header as packets that are already in the stream will almost certainly corrupt the stream, and putting additional data in transport stream packets with a different PID value will not cause corruption. Thus, one way to avoid interference is to use different PID values for the local data than what is used for the global data.

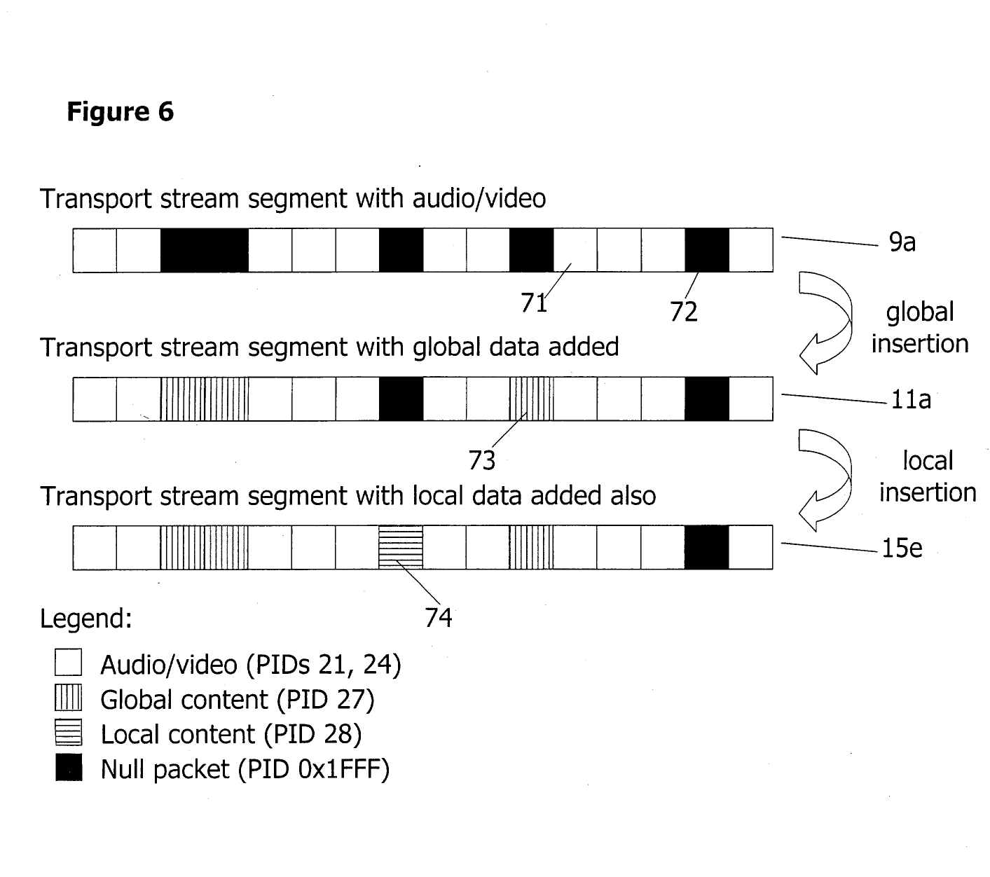

FIG. 6 illustrates one way PID values can be used to make sure there is no interference between global and local content. The initial transport stream 9a has only audio/video packets 71, shown in FIG. 6 as squares in white, and null (empty) packets 72, shown in FIG. 6 as squares in black. In this example the audio packets use PID value 24 and the video packets use PID value 21. The global data insertion system 10a can insert global content (which in an ATVEF broadcast could consist of announcements, triggers, and global enhancements) into packets 73 with PID value 27, shown in FIG. 6 as squares with vertical stripes, producing a transport stream 11a ready to be broadcast to local sites. A local data insertion system 10b, 10d can then insert local content (which in an ATVEF broadcast could consist of just local enhancements) into packets 74 with PID value 28, shown in FIG. 6 as squares with horizontal stripes, resulting in a transport stream 15e ready to broadcast at the local level.

Achieving this separation is straightforward. All that is needed is for the scheduling metadata 23 in the global data insertion system 10a to specify PID value 27 as the broadcast address 44 for all content, and for the scheduling metadata 23 in the local data insertion systems 10b, 10d to specify PID value 28 as the broadcast address 44 for all content.

The multiplexer 27a at the local data insertion systems 12b, 12d would be configured to put both PID values 27 and 28 in the MPEG-2 Program Map Table section for the program containing the enhancements.

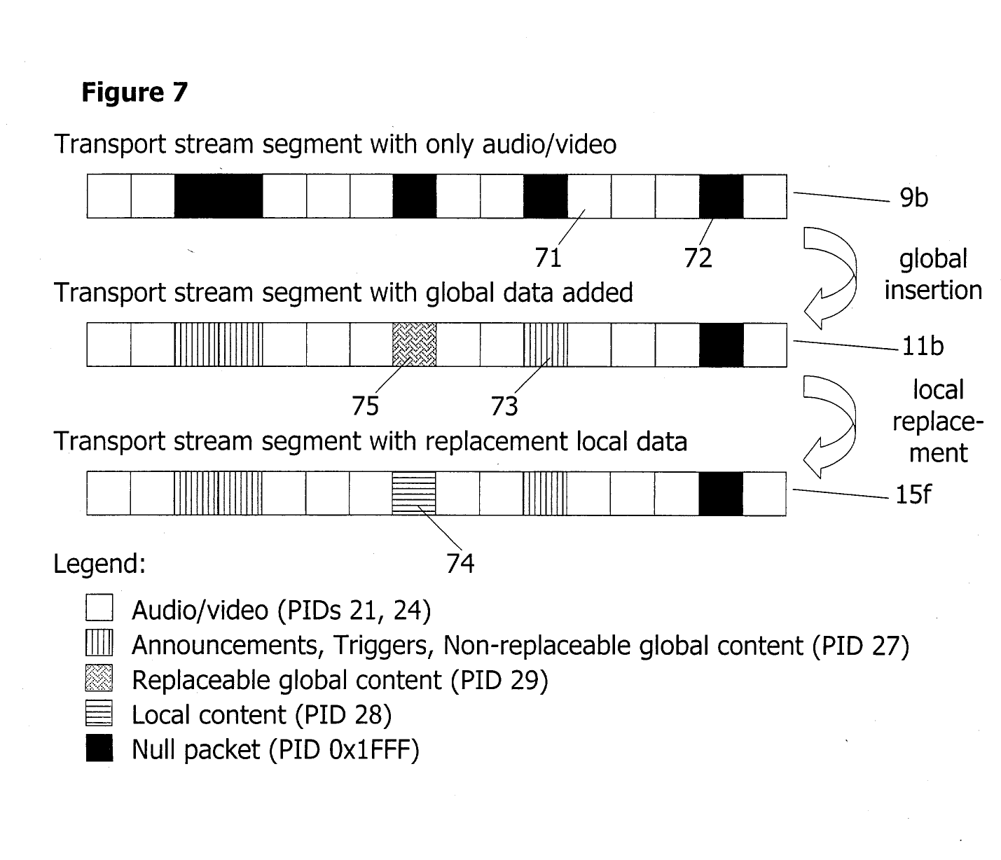

This approach to combining global and local content has the disadvantage that at any local site where local content is not inserted the end users may see periods of time where there is no data content available. To eliminate this problem it is possible to insert a full set of global content and allow local sites to replace some of the global content with local content. FIG. 7 illustrates how this can be done very easily.

The initial transport stream 9b has only audio/video packets 71, shown in FIG. 7 as squares in white, and null (empty) packets 72, shown in FIG. 7 as squares in black. In this example the audio packets use PID value 24 and the video packets use PID value 21. The global data insertion system 10a can insert global content that is not intended to be replaced by local sites into packets 73 with PID value 27, shown as squares with vertical stripes, and global content that is intended to be optionally replaced by local sites into packets 75 with PID value 29, shown as squares with a plaid pattern, producing a transport stream 11b ready to be broadcast to local sites. A local Data Insertion System 10b, 10d can then insert local content into packets 74 with PID value 28, shown as squares with horizontal stripes, and configure the multiplexer 27a of the local Data Insertion System to drop packets with PID value 29, resulting in a transport stream 15f ready to broadcast at the local level.

The ATVEF specification uses IP packets for all announcements, triggers, and enhancements. In a digital television environment these IP packets are encapsulated into MPEG-2 transport stream packets and multiplexed into the MPEG-2 transport stream for broadcast.

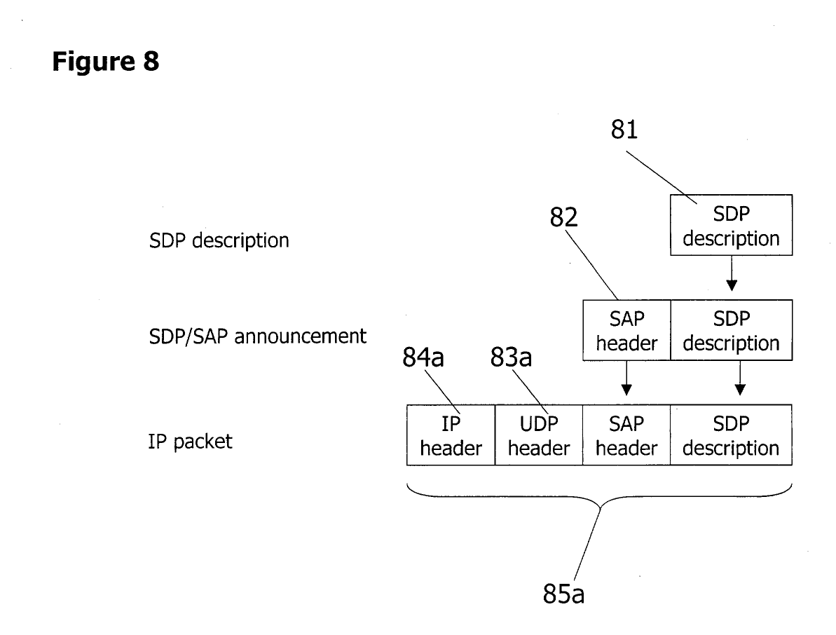

FIG. 8 illustrates how the SDP/SAP (Service Description Protocol/Session Announcement Protocol) announcements are encapsulated, according to the relevant standards. First the SDP description 81 of a session is generated. Then an SAP header 82 is concatenated onto the front of it. Then UDP and IP headers 83a, 84a are concatenated onto the front of that. The result is an IP packet 85a.

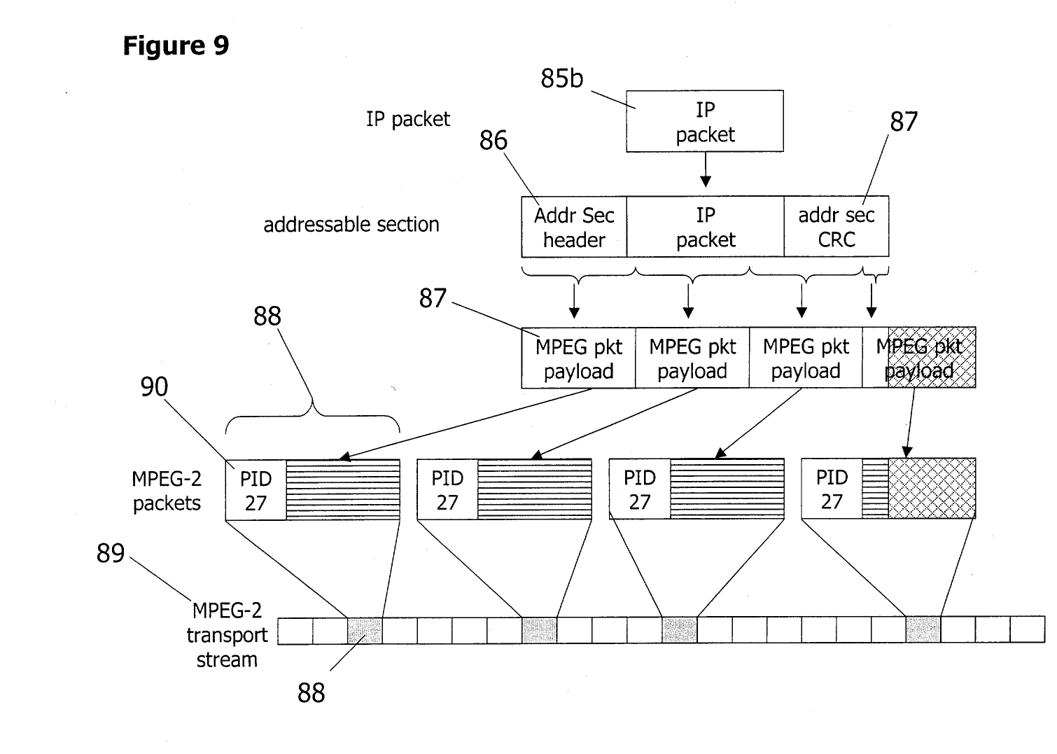

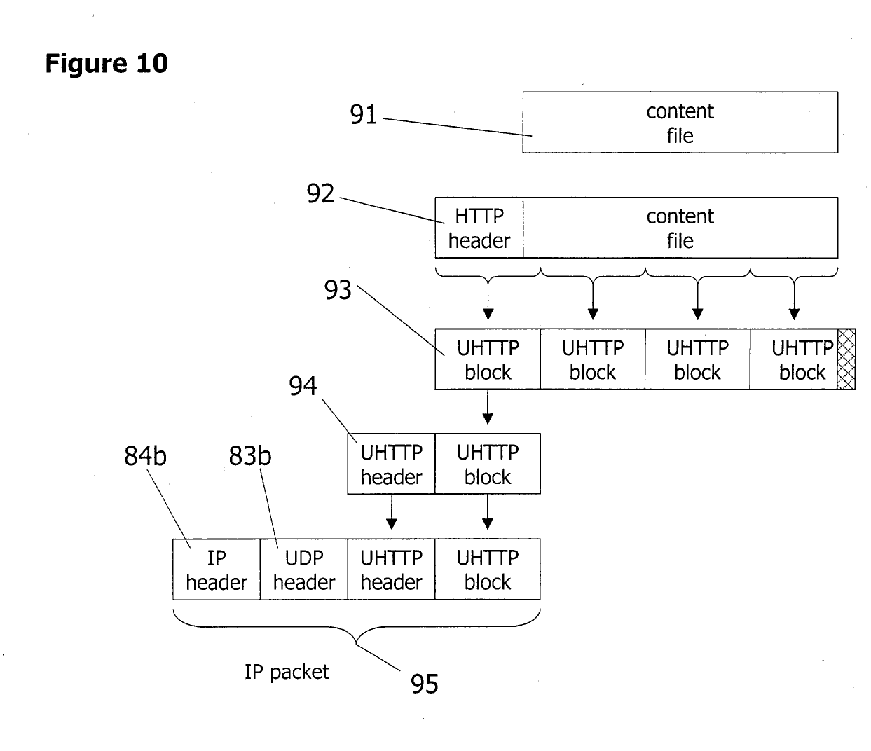

FIG. 9 illustrates how an IP packet 85b is encapsulated into MPEG-2 transport stream packets 88 according to the relevant standards, for example when IP packets are to be included in a digital television broadcast. First an addressable section header 86 is concatenated onto the front of the IP packet and an addressable section Cyclic Redundancy Checksum (CRC) 87 is concatenated onto the back of the IP packet. Then the resulting sequence of bytes is divided up into blocks of size 184 bytes, the size of the payload of an MPEG-2 transport stream packet (with the last block perhaps being smaller, if the size of the original sequence of bytes is not exactly divisible by 184). Then a 4-byte MPEG-2 transport stream packet header 90 is concatenated onto the front of each block, with an appropriate PID value in the header. This gives a sequence of transport packets that can be multiplexed into an MPEG-2 transport stream 89.

FIG. 9 illustrates how a content file 91 is encapsulated into IP packets according to the UHTTP standard. First an HTTP-style header 92 is concatenated onto the front of the file, giving certain information about the file. Then the resulting sequence of bytes is divided into blocks 93 of equal size (except for the last block, which may be smaller than the others). If the file is to be transmitted in a digital television broadcast, these blocks should be no larger than about 4000 bytes, since addressable sections will not hold IP packets very much larger than this. Then a UHTTP header 94 is concatenated onto the front of each block 93, and UDP and IP headers 83b, 84b are concatenated onto the front of this to form a complete IP packet 95. If it is desired to transmit the file in a digital television broadcast, the IP packets can then be encapsulated in MPEG-2 transport stream packets as illustrated in FIG. 8.

2. Targeting Information

In many situations it is desirable for multiple versions of data content to be contained in a broadcast stream, and for each individual receiver to select a version to present to the user or users, with the selection based on the viewer's geographical location, viewing preferences, demographic characteristics, interactive choice, or other factors. The necessary information about the viewer's geographical location could be entered into the receiver by the viewer during a “setup” step, or, if the viewer is a cable subscriber with an addressable receiver (e.g., cable set-top box), it could be downloaded into the receiver from the cable operator's subscriber database. The necessary information about the viewer's viewing preferences could entered by the viewer during setup, or could be inferred by the receiver over time from the viewer's actual selections of programs to watch. The necessary information about the viewer's demographic characteristics could be entered by the viewer during setup.

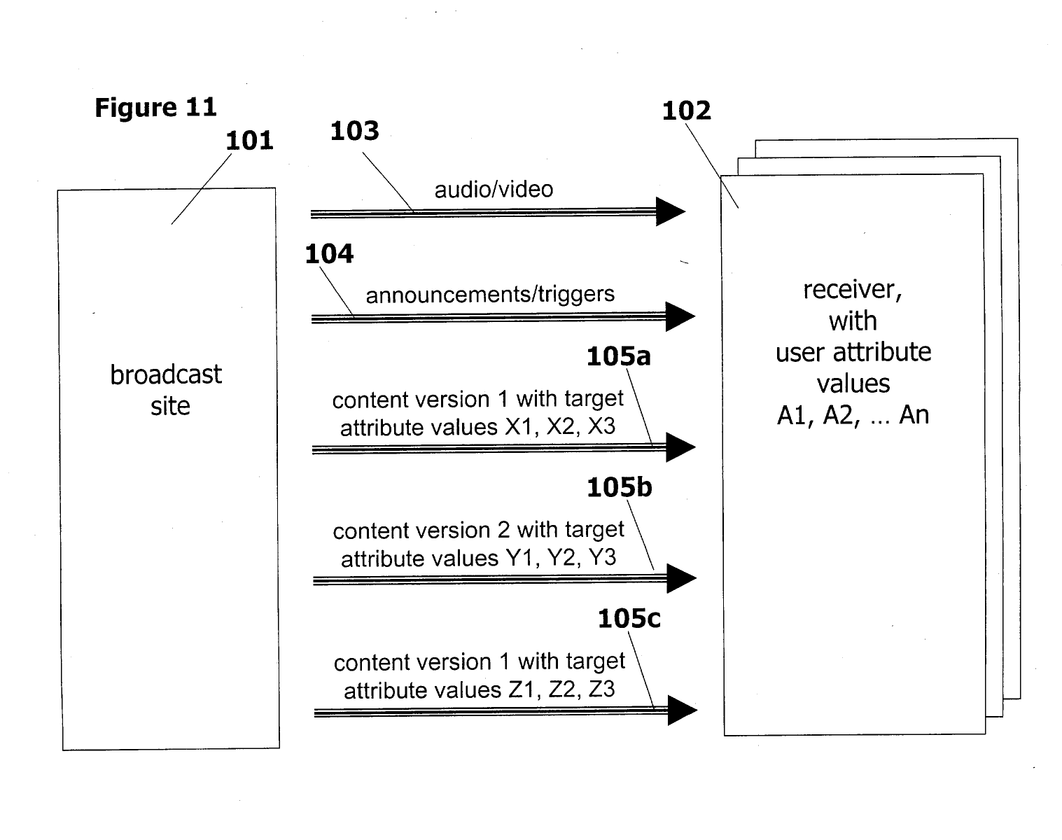

FIG. 11 illustrates a general method for achieving such targeting of content to users, according to the present invention. A broadcast site 101 sends out a broadcast stream that may include audio/video 103, announcements and triggers 104, and multiple content versions 105a, 105b, 105c, each version having associated with it in the broadcast stream a set of attribute values that characterize a target set of users for the broadcast. The broadcast is received by receivers 102, each of which has a set of attribute values that characterize the user or users at that site. Then a data extraction module at each site can select the content version with the best match between the user attribute values at that site and the target attribute values associated with the version, and that version can be presented to the user.

The present invention is not concerned with the specific types of attribute values used, nor with the algorithms used to determine the best match. It is concerned instead with mechanisms to associate attribute values with content in the broadcast stream and access the attribute values accordingly.

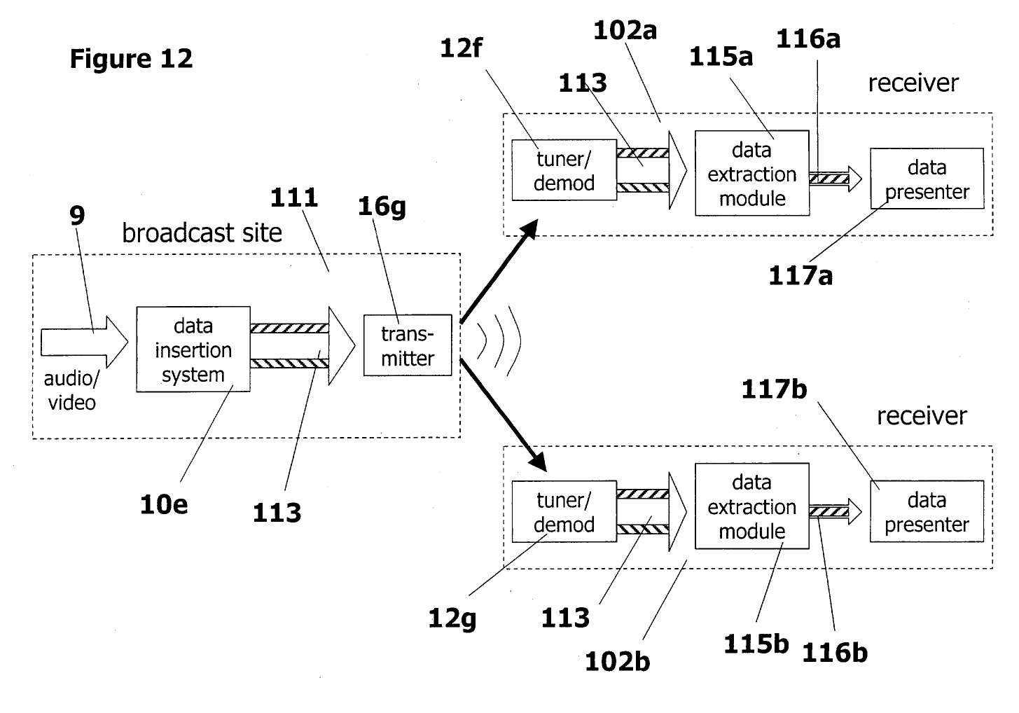

FIG. 12 shows a system architecture for an embodiment of the present invention for targeting data. A broadcast site 111 can generate a broadcast transmission. An audio/video stream 9 may be part of the broadcast. A data insertion system 10e may insert multiple versions of data content into the broadcast stream, producing an augmented broadcast stream 113, which may be sent to a transmitter 16g for broadcast. The broadcast signal may be received by multiple receivers 114a, 114b. At each receiver 114a, 114b a tuner/demod device 12f, 12g gets the augmented broadcast stream from the broadcast and feeds it to a data extraction module 115a, 115b. The data extraction module extracts the most suitable version 116a, 116b of the content and feeds it to the data presenter module 117a, 117b.

The data insertion system 118 can be the same as those described in FIGS. 2 or 3. Transmitters and tuner/demod devices are widely available from many vendors. The data extraction modules 115a, 115b may be simply slight variations on the standard data extraction components that are widely available for the various different standard data broadcast protocols. All that is needed is to add the ability to select the appropriate version as indicated by the targeting attribute values. This involves simply parsing the attribute values out of signaling data structures in the broadcast that the standard data extraction components need to access in any case, and then making a selection based on these values. In a simple case each version of content may have a single value of a single attribute associated with it, such as a postal zip code, with different values for different versions, and each receiver may have a single value of the same attribute associated with it, and the data extraction module 115a, 115b can simply select the content version with an attribute value that matches the user attribute value. The data presenter modules 117a, 117b could be software on personal computers that is capable of rendering whatever type of data is being sent (for example, Flash or QuickTime animation, or ATVEF-compliant content). In many situations the tuner/demod device, data extraction module, and data presenter can all be implemented together in the same box, often a personal computer with a standard DTV adapter or Ethernet adapter in it.

It is also possible for the receiver to rebroadcast the content it selects to a local audience.

When ATVEF data enhancements are being used in such a situation, there are a number of methods that can be used to achieve the desired result according to the present invention. All of the methods are based on the idea of using signaling mechanisms that already exist in the broadcast stream for other purposes, and adapting them to provide a labeling of the different versions with different attribute values that can be used to make the selection.

The techniques and methods described herein and below could be included in future versions of the relevant standards, so that all standard receivers could support targeting, or receivers that do not support targeting would have a standard way to select a generic, non-targeted version of the content:

### PMT Descriptor Method

The MPEG-2 standard allows each PID value listed in a PMT to have so-called “descriptors” associated with it. These descriptors supply various types of information about the so-called “program element” consisting of those transport stream packets with that PID value. The standard defines certain descriptors that provide certain standard types of information. In addition, the standard allows so-called “private” descriptors to be defined that provide application-specific information about program elements.

Thus, one can put multiple versions of enhancement content in transport stream packets with different PIDs, and associate with each PID in the PMT an instance of a private descriptor that contains one or more attribute values which characterize the viewers to be targeted by that version of the enhancement. Then when the data extraction module looks in the PMT to discover what data PIDs to monitor for the enhancement content, it can parse these values out, compare the attribute values associated with each data PID against the attributes of the viewer, pick the best match, and take the content only from that PID.

In order to provide the maximum flexibility to target different combinations of enhancements to viewers with different combinations of characteristics at different points throughout a program, the private descriptors to be inserted into the PMT could be changed each time a new enhancement time slot comes along. This could cause the receivers to switch PIDs as needed to get the most suitable version of the enhancement each time.

With this method as described, a conventional ATVEF receiver would not know to look at the private descriptors, and would just take all the content from all the data PIDs simultaneously. Since the different versions of the content are all intended to be triggered by the same triggers, they would all have the same URLs identifying them, and the resulting duplications of URLs would confuse the receiver badly. This problem can be solved by setting the stream_type of one of the data PIDs to 0x0D, the standard stream_type for addressable sections, and setting the stream_type of the other PIDs to some private stream_type.

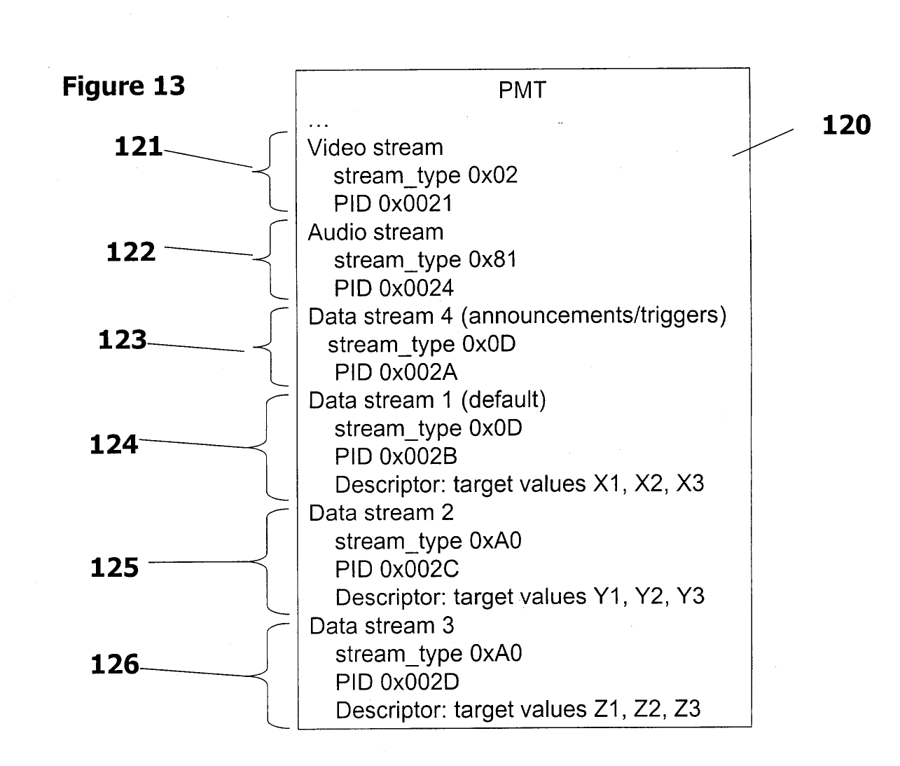

FIG. 13 illustrates this solution. For this example PID 2A contains the announcements and triggers, PID 2B contains a “default” enhancement version more or less suitable for all users, and PIDs 2C and 2D contain other enhancement versions. The first entry 121 in the PMT 120 signals that PID 21 contains a video stream, the second PMT entry 122 signals that PID 24 contains an audio stream. The next two entries 123, 124 signal that PIDs 2A and 2B contain streams of type 0x0D, which is the stream type for addressable sections. The final two entries 125, 126 signal that PIDs 2C and 2D contain streams of type 0xA0, which is a non-standard stream type that will not be recognized by standard receivers. Thus, a standard receiver with a standard data extraction component that does not know about targeting will extract the addressable sections from PIDs 2A and 2B and ignore PIDs 2C and 2D, getting just the default enhancement. However, a modified data extraction module 115a, 115b that knows about targeting would know that PIDs of stream type 0xA0 also contain addressable sections. It would therefore check the targeting descriptors associated with PIDs 2B, 2C, and 2D, and extract addressable sections only for the one that has the best attribute match.

Thus, this method allows modified receivers to select targeted content, while still allowing standard receivers to perform satisfactorily.

### SDP/SAP Stream Identification Method

The SDP/SAP announcements for an ATVEF enhancement “session” signal the IP multicast destination addresses and ports of the UDP/IP packets containing the triggers and the content. It is possible to include in the broadcast stream multiple streams of content, with different IP addresses and ports, and to signal these multiple streams of content in the SDP/SAP announcements. Moreover, it is possible to include in the announcements application-specific properties for each content stream, such as a list of targeting keywords. Then a special receiver modified to support the targeting could examine the lists of targeting keywords select the most suitable content stream, and use only the IP packets with the destination address and port of that stream.

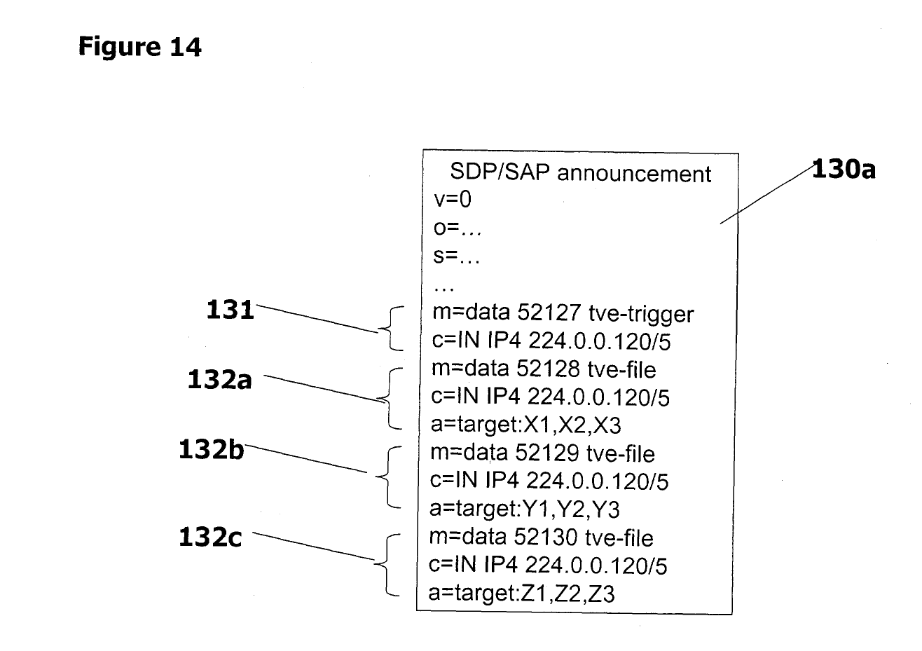

FIG. 14 illustrates this method. The SDP/SAP announcement 130a includes a block 131 that identifies a stream with IP address/port combination 224.0.0.120/52127 as containing ATVEF triggers, a block 132a that identifies a stream with IP address/port combination 224.0.0.120/52128 as containing ATVEF content files, a block 133a that identifies a stream with IP address/port combination 224.0.0.120/52129 as containing ATVEF content files, and a block 134a that identifies a stream with IP address/port combination 224.0.0.120/52130 as containing ATVEF content files. The three blocks 132a, 133a, 134a also contain a private, non-standard line that contains targeting attribute values.

A modified data extraction module 115a, 115b that looks at the SDP/SAP announcements to discover the IP addresses where the content can be found would know to parse the values from the targeting attribute lines and use them to select the best version of the enhancement files. Unfortunately, a standard data extraction device would not know to examine the attribute values, and it would assume that all three IP address/port combinations give valuable enhancements, so it would extract all three versions and attempt to use them concurrently. Thus, this method will work best in an application where no unmodified receivers are being used.

### SDP/SAP Session Identification Method

The SDP/SAP announcements for an ATVEF enhancement “session” may have a “tve-type” attribute that describes the type of session. The ATVEF specification defines tve-type “primary” to indicate that the session contains the primary ATVEF enhancement stream, i.e., the one to be used under normal conditions. It is also possible to define additional application-specific attributes for a session.

Thus, the broadcast stream can contain multiple different versions of the enhancement content, which can be delivered in IP multicast packets with different IP addresses or ports. SDP/SAP announcements for multiple sessions can be included in the broadcast stream, with the announcements for each session referencing the IP address and port of one version of the content. All of the announcements can reference a common IP address and port for the common triggers. The IP packets with the IP address and port referenced by one of the sessions can contain a generic version of the content, more or less suitable for all viewers. This session announcement can have the tve-type attribute set to “primary”. The other session announcements can all have the tve-type attribute set to something like “targeted”, or just have the tve-type attribute omitted. All the session announcements can also contain an application-specific attribute that gives the targeting criteria.

A standard ATVEF receiver would look at the multiple session announcements, select the one with the tve-type attribute set to “primary”, and get the content from the IP packets with the IP address and port specified for that session. An ATVEF receiver that is modified to be used for targeted enhancements according to this method would look at all the multiple session announcements and select from those the session that had the best match between the targeting criteria attribute and the characteristics of the viewer. The receiver would then get the content from the IP packets with the IP address and port specified for the selected session and ignore the others.

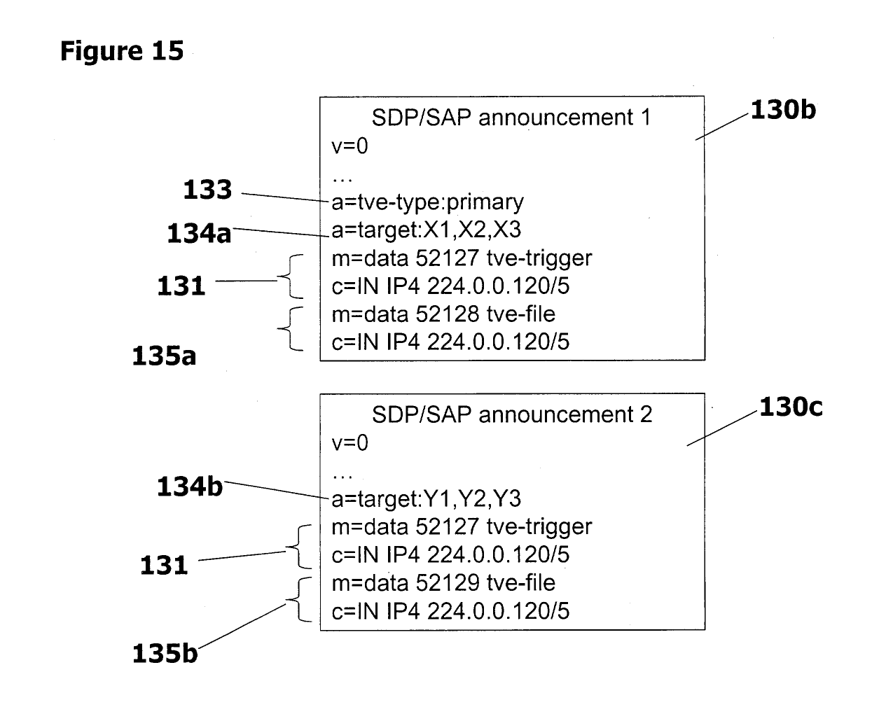

Note that the entries in the SDP/SAP announcements that give the targeting attributes have the same syntax in the example in FIG. 15 as in the example in FIG. 14. However, the location of the entries is significant. In FIG. 14 the entries are providing targeting information associated with a single stream of a session. In FIG. 15 the entries are providing targeting information associated with the entire session

Thus, this method of the present invention would enable modified receivers to handle targeting, and would still allow standard receivers to work satisfactorily.

In order to provide the maximum flexibility to target different combinations of enhancements to viewers with different combinations of characteristics at different points throughout a program, the targeting criteria attributes in the session announcements could be changed each time a new enhancement time slot comes along. This could cause the receivers to switch sessions as needed to get the most suitable version of the enhancement each time.

FIG. 15 illustrates this method. One SDP/SAP session announcement 130b has an entry 133 that identifies the session as of tve-type primary, another entry 134a that gives targeting attribute values for that session, a block 131 that identifies the triggers for the session as appearing in address/port combination 224.0.0.120/52127, and a block 135a that identifies enhancement files for the session as appearing in address/port combination 224.0.0.120/52128. Another SDP/SAP session announcement 130c has an entry 134b that gives targeting attribute values for that session, a block 131 that identifies the triggers for the session as appearing in address/port combination 224.0.0.120/52127, and a block 135b that identifies enhancement files for the session as appearing in address/port combination 224.0.0.120/52129.

A standard receiver should select the “primary” session announced by SDP/SAP session announcement 130b and ignore the other one. A modified receiver that understands about targeting could compare the targeting attribute blocks 134a, 134b and select the session with the best match.

### Content File Header Method

The HTTP-like header for each ATVEF content file can have private attributes defined in. it, as well as standard attributes such as the URL to be used to identify the file. Thus, all of the different versions of content files can be put into a single PID, and one or more private attributes can be used in the file headers to identify the types of viewers to be targeted by each version of each file. A receiver can then extract all of the content files from the broadcast stream, but save in cache only the version of each file that is the best match for the viewer, and discard the others.

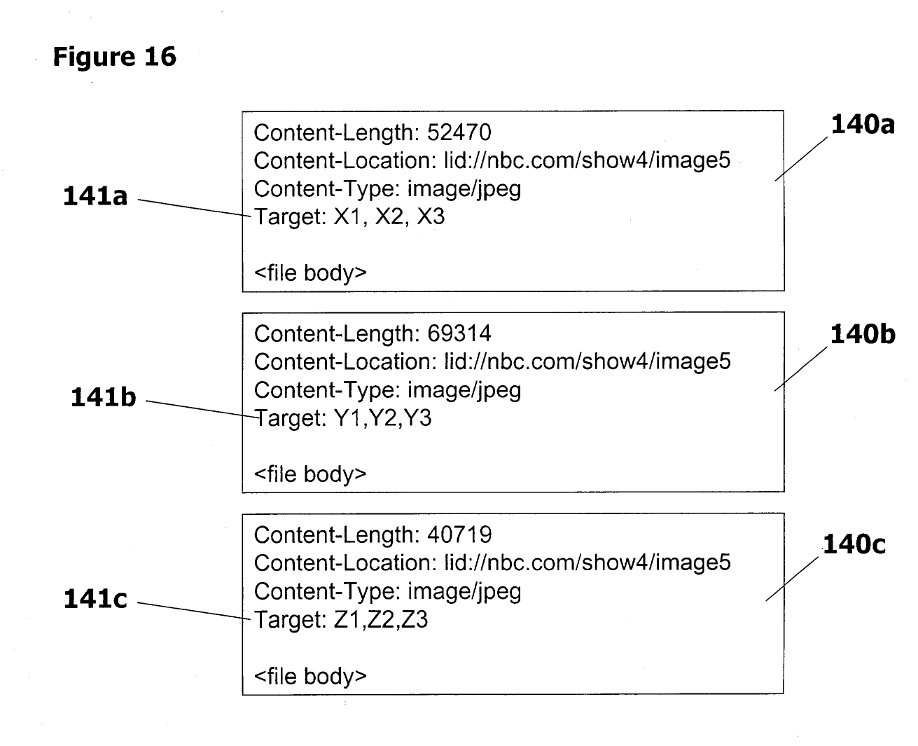

FIG. 16 illustrates this method. It shows the HTTP-style headers 140a, 140b, 140c of three files. They are all versions of the same file, as indicated by the fact that they all have the same URL in the Content-Location field. (i.e., any time that URL is referenced, whichever one of the three that is saved in the ATVEF receiver cache will be displayed.) Each header has a targeting attribute list 141a, 141b, 141c, identified by the “Target” tag.

A modified ATVEF receiver that knows about targeting can examine the targeting attributes in the three headers and select the best match. Unfortunately, a standard ATVEF receiver would not know about these attributes and would simply save in cache the first of these versions that it sees in the broadcast. Thus, this method works best when all ATVEF receivers in the system are modified to support targeting.

Although it seems like the data insertion system would have to be more complex to support the insertion of multiple versions to support targeting, in fact the extra complexity can be handled by just including the multiple content versions in the content data storage 24 and including scheduling records for all of the versions in the scheduling metadata 23. The SDP/SAP announcements can also be treated just as content to be broadcast, so any extra targeting information in the announcements can just be added to them with an ordinary text editor before they are put in the content data storage. However, some extra logic is required in data extraction modules to handle selection of correct versions.

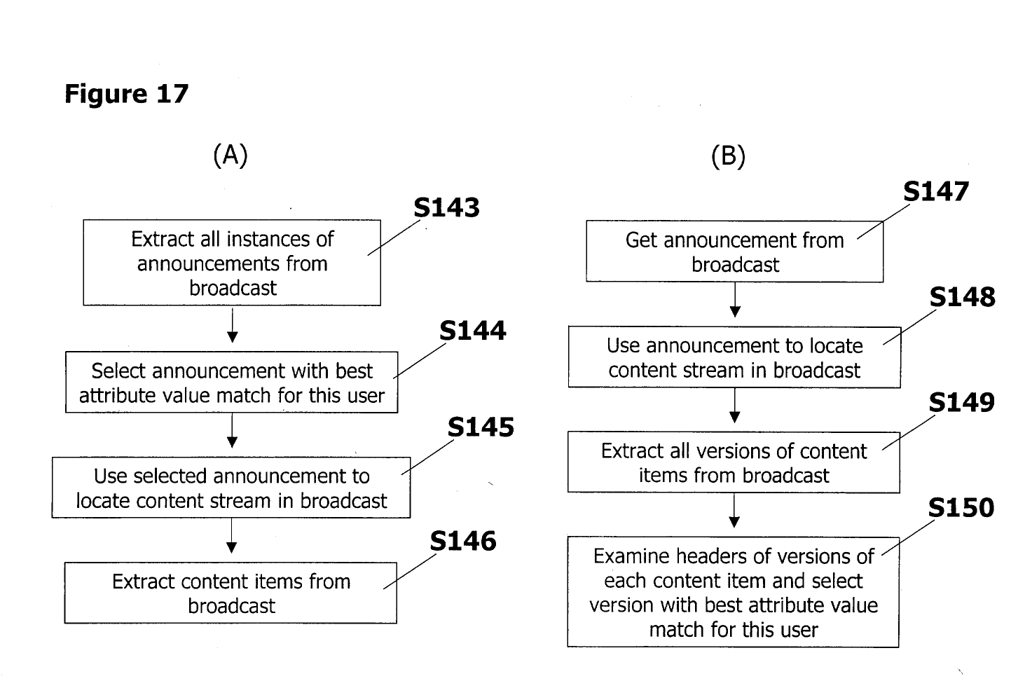

FIG. 17A describes the data extraction module logic for methods that use attributes in the announcements, such as the PMT descriptor method, the SDP/SAP stream identification method, and the SDP/SAP session identification method. The first step S143 is to extract all instances of the announcements from the broadcast. For the PMT descriptor method, for example, this would mean extracting the blocks describing all the PIDs in the PMT section describing the channel of interest. The next step S144 is to select the announcement with the best attribute match for this user. For the PMT descriptor method, for example, this would mean determining which PID to use. The next step S145 is to use the selected announcement to locate the content in the broadcast. The final step S146 is to extract the content and turn it over to the data presenter module.

FIG. 17B describes the data extraction module logic for methods that use something in the content itself, such as the content file header method that uses a field in the HTTP-style file header. The first step S147 in this case is to extract the announcement from the broadcast. (There is no need to select an announcement, since the selection is done at the content level, rather than the announcement level.) The next step S148 is to use the announcement to locate the content in the broadcast. The third step S149 is to extract all versions of the content items from the broadcast stream. The final step is to examine all the versions of the content and use the targeting attribute values attached to the content to select the most appropriate version of each content item and turn it over to the Data User module.

One embodiment of the present invention could be in the context of the ATVEF specification (now SMPTE Standard 357M-2002, “Television—Declarative Data Essence—Internet Protocol Multicast Encapsulation”), with the IP packets contained in a digital television (DTV) broadcast conforming to the ATSC DTV standards, using the addressable section encapsulation for IP packets as specified in the ATSC Data Broadcast Standard (ATSC Document A/90). However, the present invention is equally applicable to other mechanisms for the broadcast of interactive data programming and other types of data.

All the processing steps/logics discussed herein are implementable using on computer-readable media, and can be implemented using any existing computer programming language. The computer-readable media can be computer-accessible storage(s) and/or computer device(s) such as PCs, workstations, servers, etc., and/or computer systems(s).

The invention being thus described, it will be obvious that the same may be varied in many ways. For example, the present invention may be applicable to inserting any other types of information into a broadcast or communication stream in a local level. All such variations are not to be regarded as a departure from the spirit and scope of the invention. Further, it should be understood that the detailed description and specific examples, while indicating preferred embodiments of the invention, are given by way of illustration only, since various changes and modifications within the spirit and scope of the invention will become apparent to those skilled in the art from this detailed description.

1. A method of providing localized data, the method comprising:
receiving, at at least one of a plurality of local broadcast sites, a broadcast stream carrying global data; and
inserting, at said at least one of local broadcast sites, localized data associated with said at least one of local broadcast sites into the received broadcast stream, so as to generate a modified broadcast stream carrying the global data and the localized data at said at least one of local broadcast sites.

2. The method of claim 1, wherein the inserting step includes:
receiving an incoming MPEG-2 transport stream carrying the global data;
generating, by said at least one of local broadcast sites and according to scheduling information, an additional MPEG-2 transport stream carrying said localized data; and
multiplexing the incoming MPEG-2 transport stream and the additional MPEG-2 transport stream to generate the modified broadcast stream.

3. The method of claim 1, wherein, in the receiving step, the global data are carried in the broadcast stream using first packet identification (PID) values; and
wherein the inserting step includes:
inserting said localized data into the broadcast stream carrying the global data, using second PID values different from the first PID values.

4. The method of claim 1, wherein, in the receiving step, the global data carried in the broadcast stream include replaceable global content and non-replaceable global content which are carried in the broadcast stream using different packet identification (PID) values.

5. The method of claim 4, wherein the inserting step includes:
replacing the replaceable global content with said localized data in the broadcast stream using the PID values.

6. The method of claim 1, wherein the received broadcast stream uses IP multicast packets, and the inserting step includes:
generating an IP packet stream carrying IP packets of said localized data according to scheduling information, so as to route the IP packet stream over a network.

7. The method of claim 1, further comprising:
generating, at a global broadcast site, the broadcast stream carrying the global data; and
transmitting the broadcast stream carrying the global data to all the local broadcast sites.

8. The method of claim 7, wherein the global broadcast site is a national television network, and the local broadcast sites are local television stations.

9. The method of claim 1, wherein said localized data are enhancement data for audio and/or video.

10. The method of claim 1, further comprising:
broadcasting the modified broadcast stream to user sites.

11. An apparatus for providing localized data at a local broadcast site, the apparatus comprising:
a receiver to receive a broadcast stream carrying global data; and
an insertion section to insert localized data associated with the local broadcast site into the received broadcast stream, and thereby generate a modified broadcast stream carrying the global data and the localized data at the local broadcast site.

12. The apparatus of claim 11, wherein the insertion section includes:
a data server to generate an additional MPEG-2 transport stream carrying said localized data according to scheduling information; and
a multiplexer to combine an incoming MPEG-2 transport stream carrying the global data with the additional MPEG-2 transport stream and thereby generate the modified broadcast stream.

13. The apparatus of claim 11, wherein the global data are carried in the broadcast stream using first packet identification (PID) values, and the insertion section inserts said localized data into the broadcast stream carrying the global data, using second PID values different from the first PID values.

14. The apparatus of claim 11, wherein the global data carried in the broadcast stream include replaceable global content and non-replaceable global content which are carried in the broadcast stream using different packet identification (PID) values.

15. The apparatus of claim 14, wherein the insertion section replaces the replaceable global content with said localized data in the broadcast stream using the PID values.

16. The apparatus of claim 14, wherein the insertion section includes:
a data server to generate an IP packet stream carrying IP packets of said localized data according to scheduling information; and
wherein the apparatus further comprises:
an IP router to route the IP packet stream over a network.

17. The apparatus of claim 11, wherein said localized data are enhancement data for audio and/or video.

18. The apparatus of claim 11, further comprising:
means for broadcasting the modified broadcast stream to user sites

19. A system for providing localized data at a local broadcast site, the system comprising:
a global generator to generate, at a global broadcast site, a broadcast stream carrying global data and to transmit the broadcast stream carrying the global data to a plurality of local broadcast sites; and
the plurality of local broadcast sites each including,
a receiver to receive the broadcast stream carrying the global data, and
an insertion section to insert localized data associated with the corresponding local broadcast site into the received broadcast stream, and thereby generate a modified broadcast stream carrying the global data and said localized data at the corresponding local broadcast site.

20. The system of claim 19, wherein the insertion section includes:
a data server to generate an additional MPEG-2 transport stream carrying said localized data according to scheduling information associated with the corresponding local broadcast site; and
a multiplexer to combine an incoming MPEG-2 transport stream carrying the global data with the additional MPEG-2 transport stream and thereby generate the modified broadcast stream.

21. The system of claim 19, wherein the global data are carried in the broadcast stream using first packet identification (PID) values, and the insertion section at the corresponding local broadcast site inserts said localized data into the broadcast stream carrying the global data, using second PID values different from the first PID values.

22. The system of claim 19, wherein the global data carried in the broadcast stream include replaceable global content and non-replaceable global content which are carried in the broadcast stream using different packet identification (PID) values, and the insertion section at the corresponding local broadcast site replaces the replaceable global content with said localized data in the broadcast stream using the PID values.

23. The system of claim 19, wherein the insertion section includes:
a data server to generate an IP packet stream carrying IP packets of said localized data according to scheduling information associated with the corresponding local broadest site; and
wherein each of the local broadcast sites further includes:
an IP router to route the IP packet stream generated at the corresponding local broadcast site over a network.

24. The system of claim 19, wherein said localized data are enhancement data for audio and/or video.

25. The system of claim 19, wherein each of the local broadcast sites further includes:
means for broadcasting the modified broadcast stream to user sites associated with the corresponding local broadcast site.

26. The system of claim 19, wherein the global broadcast site is a national television network, and the local broadcast sites are local television stations.

27. A computer program product embodied on computer readable media, for providing localized data, the computer program product comprising computer-executable instructions for:
receiving, at at least one of a plurality of local broadcast sites, a broadcast stream carrying global data; and
inserting, at said at least one of local broadcast sites, localized data associated with said at least one of local broadcast sites into the received broadcast stream, so as to generate a modified broadcast stream carrying the global data and the localized data at said at least one of local broadcast sites.

28. The computer program product of claim 27, wherein the computer-executable instructions for inserting include computer-executable instructions for:
receiving an incoming MPEG-2 transport stream carrying the global data;
generating, by said at least one of local broadcast sites and according to scheduling information, an additional MPEG-2 transport stream carrying said localized data; and
multiplexing the incoming MPEG-2 transport stream and the additional MPEG-2 transport stream to generate the modified broadcast stream.

29. The computer program product of claim 27, wherein the global data are carried in the broadcast stream using first packet identification (PID) values; and
wherein the computer-executable instructions for inserting include computer-executable instructions for:
inserting said localized data into the broadcast stream carrying the global data, using second PID values different from the first PID values.

30. The computer program product of claim 27, wherein the global data carried in the broadcast stream include replaceable global content and non-replaceable global content which are carried in the broadcast stream using different packet identification (PID) values.

31. The computer program product of claim 30, wherein the computer-executable instructions for inserting include computer-executable instructions for:
replacing the replaceable global content with said localized data in the broadcast stream using the PID values.

32. The computer program product of claim 27, wherein the received broadcast stream uses IP multicast packets and the computer-executable instructions for inserting include:
generating an IP packet stream carrying IP packets of said localized data according to scheduling information, so as to route the IP packet stream over a network.

33. The computer program product of claim 27, further comprising computer-executable instructions for:
generating, at a global broadcast site, the broadcast stream carrying the global data; and
transmitting the broadcast stream carrying the global data to all the local broadcast sites.

34. The computer program product of claim 33, wherein the global broadcast site is a national television network, and the local broadcast sites are local television stations.

35. The computer program product of claim 27, wherein said localized data are enhancement data for audio and/or video.

36. The computer program product of claim 27, further comprising computer-executable instructions for:
broadcasting the modified broadcast stream to user sites.

37. A method of providing targeted data, the method comprising:
receiving a broadcast including a plurality of content streams, each of the content streams carrying targeted content data having certain targeting attributes; and
selecting, by a selection device, one of the content streams based on the targeting attributes and attributes of a receiving party serviced by the selection device.

38. The method of claim 37, wherein the selecting step includes:
extracting instances of announcements from the broadcast, each of the announcements having attribute information;
selecting one of the announcements that has the attribute information best matching the attributes of the receiving party; and
obtaining one of the content streams based on the selected announcement.

39. The method of claim 38, further comprising:
presenting the obtained content stream to the receiving party or re-broadcasting the obtained content stream to the receiving party.

40. The method of claim 38, wherein the receiving party is a single user or a group of users.

41. The method of claim 37, wherein the selecting step is performed using descriptors in a program map table (PMT) of the broadcast, service description protocol/service announcement protocol (SDP/SAP) announcements from the broadcast, or header information of content files in the broadcast.

42. The method of claim 37, wherein the selecting step includes:
extracting data blocks in a program map table (PMT) of the broadcast, each of the data blocks being associated with one of the content streams, and having a packet identification (PID) assigned thereto and descriptor information identifying attribute information associated with the corresponding content stream.

43. The method of claim 42, wherein the selecting step further includes:
examining the PIDs and the description information of the data blocks;
selecting one of the data blocks that has the descriptor information that best matches the attributes of the receiving party; and
locating a content stream associated with the selected data block from the broadcast, so as to broadcast the located content stream to the receiving party.

44. The method of claim 37, wherein the selecting step includes:
examining at least one announcement from the broadcast, said announcement carrying data blocks being associated with one of the content streams, each of the data blocks including IP address and port information that identifies one of the content streams and attribute information associated with the identified content stream.

45. The method of claim 44, wherein the selecting step further includes:
selecting one of the data blocks that has the attribute information that best matches the attributes of the receiving party; and
locating a content stream associated with the selected data block from the broadcast, so as to broadcast the located content stream to the receiving party.

46. The method of claim 44, wherein the examining step exams a plurality of the announcements from the broadcast, and wherein the selecting step further includes:
comparing the announcements with each other; and
selecting one of the announcements or a data stream from one of the announcements that carries at least one data block that best matches the attributes of the receiving party.

47. The method of claim 37, wherein the selecting step includes:
examining header information of multiple versions of each of a plurality of content files in the content streams, the header information of each version of the files carrying attribute information identifying attributes of an appropriate receiving party of the corresponding version; and
selecting one of the versions for the content files based on the attribute information.

48. The method of claim 37, wherein the broadcast is in an MPEG-2 transport format or an IP multicast format.

49. The method of claim 37, wherein the selecting step by the selection device is performed at a user site or at a local broadcast site.

50. An apparatus for providing targeted data, the apparatus comprising:
a receiver to receive a broadcast including a plurality of content streams, each of the content streams carrying targeted content data having certain targeting attributes; and
a selection device to select one of the content streams based on the targeting attributes and attributes of a receiving party serviced by the selection device

51. The apparatus of claim 50, wherein the selection device includes:
means for extracting instances of announcements from the broadcast, each of the announcements having attribute information;
means for selecting one of the announcements that has the attribute information best matching the attributes of the receiving party; and
means for obtaining one of the content streams based on the selected announcement.

52. The apparatus of claim 51, further comprising:
means for broadcasting the obtained content stream to the receiving party or means for presenting the obtained content stream to the receiving party.

53. The apparatus of claim 51, wherein the receiving party is a single user or a group of users.

54. The apparatus of claim 50, wherein the selection device selects the content stream using descriptors in a program map table (PMT) of the broadcast, service description protocol/service announcement protocol (SDP/SAP) announcements from the broadcast, or header information of content files in the broadcast.

55. The apparatus of claim 50, wherein the selection device includes:
means for extracting data blocks in a program map table (PMT) of the broadcast, each of the data blocks being associated with one of the content streams, and having a packet identification (PID) assigned thereto and descriptor information identifying attribute information associated with the corresponding content stream.

56. The apparatus of claim 55, wherein the selection device further includes:
means for examining the PIDs and the description information of the data blocks;
means for selecting one of the data blocks that has the descriptor information that best matches the attributes of the receiving party; and
means for locating a content stream associated with the selected data block from the broadcast, so as to broadcast the located content stream to the receiving party.

57. The apparatus of claim 50, wherein the selection device includes:
means for examining at least one announcement from the broadcast, said announcement carrying data blocks being associated with one of the content streams, each of the data blocks including IP address and port information that identifies one of the content streams and attribute information associated with the identified content stream.

58. The apparatus of claim 57, wherein the selection device further includes:
means for selecting one of the data blocks that has the attribute information that best matches the attributes of the receiving party; and
means for locating a content stream associated with the selected data block from the broadcast, so as to broadcast the located content stream to the receiving party.

59. The apparatus of claim 57, wherein the means for examining exams a plurality of the announcements from the broadcast, and the selection device further includes:
means for comparing the announcements with each other; and
means for selecting one of the announcements or a data stream from one of the announcements that carries at least one data block that best matches the attributes of the receiving party.

60. The apparatus of claim 50, wherein the selection device includes:
means for examining header information of multiple versions of each of a plurality of content files in the content streams, the header information of each version of the files carrying attribute information identifying attributes of an appropriate receiving party of the corresponding version; and
means for selecting one of the versions for each of the content files based on the attribute information.

61. The apparatus of claim 50, wherein the broadcast is in an MPEG-2 transport format or an IP multicast format.

62. The apparatus of claim 50, wherein said selection device is located at a user site or at a local broadcast site.

63. A computer program product embodied on computer-readable media, for providing targeted data, the computer program product comprising computer-executable instructions for:
receiving a broadcast including a plurality of content streams, each of the content streams carrying targeted content data having certain targeting attributes; and
selecting, by a selection device, one of the content streams based on the targeting attributes and attributes of a receiving party serviced by the selection device.

64. The computer program product of claim 63, wherein the computer-executable instructions for selecting include computer-executable instructions for:
extracting instances of announcements from the broadcast, each of the announcements having attribute information;
selecting one of the announcements that has the attribute information best matching the attributes of the receiving party; and
obtaining one of the content streams based on the selected announcement.

65. The computer program product of claim 64, further comprising computer-executable instructions for:
presenting the obtained content stream to the receiving party or re-broadcasting the obtained content stream to the receiving party.

66. The computer program product of claim 64, wherein the receiving party is a single user or a group of users.

67. The computer program product of claim 63, wherein the selecting is performed using descriptors in a program map table (PMT) of the broadcast, announcements from the broadcast, or header information of content files in the broadcast.

68. The computer program product of claim 63, wherein the computer-executable instructions for selecting include computer-executable instructions for:
extracting data blocks in a program map table (PMT) of the broadcast, each of the data blocks being associated with one of the content streams, and having a packet identification (PID) assigned thereto and descriptor information identifying attribute information associated with the corresponding content stream.

69. The computer program product of claim 68, wherein the computer-executable instructions for selecting further include computer-executable instructions for:
examining the PIDs and the description information of the data blocks;
selecting one of the data blocks that has the descriptor information that best matches the attributes of the receiving party; and
locating a content stream associated with the selected data block from the broadcast, so as to broadcast the located content stream to the receiving party.

70. The computer program product of claim 63, wherein the computer-executable instructions for selecting include computer-executable instructions for:
examining at least one announcement from the broadcast, said announcement carrying data blocks being associated with one of the content streams, each of the data blocks including IP address and port information that identifies one of the content streams and attribute information associated with the identified content stream.

71. The computer program product of claim 70, wherein the computer-executable instructions for selecting further include computer-executable instructions for:
selecting one of the data blocks that has the attribute information that best matches the attributes of the receiving party; and
locating a content stream associated with the selected data block from the broadcast, so as to broadcast the located content stream to the receiving party.

72. The computer program product of claim 70, wherein the examining exams a plurality of the announcements from the broadcast, and wherein the computer-executable instructions for selecting further include computer-executable instructions for:
comparing the announcements with each other; and
selecting one of the announcements or a data stream from one of the announcements that carries at least one data block that best matches the attributes of the receiving party.

73. The computer program product of claim 63, wherein the computer-executable instructions for selecting include computer-executable instructions for:
examining header information of multiple versions of each of a plurality of content files in the content streams, the header information of each version of the files carrying attribute information identifying attributes of an appropriate receiving party of the corresponding version; and
selecting one of the versions for each of the content files based on the attribute information.

74. The computer program product of claim 63, wherein the broadcast is in an MPEG-2 transport format or an IP multicast format.

75. The computer program product of claim 63, wherein the selecting by the selection device is performed at a user site or at a local broadcast site.

76. A method of providing targeted data, the method comprising:
receiving, at at least one of a plurality of local broadcast sites, a broadcast stream carrying global data; and
inserting, at said at least one of local broadcast sites, sets of targeted data associated with said at least one of local broadcast sites into the received broadcast stream, the sets of targeted data each associated with one of receiving parties serviced by the corresponding local broadcast site, whereby a modified broadcast stream carrying the global data and the sets of targeted data is generated at said at least one of local broadcast sites.

77. The method of claim 76, further comprising:
receiving, at a receiving party site, the broadcast stream carrying the global data and the sets of targeted data, each of the sets of the targeted data carrying targeted content data having certain targeting attributes; and
selecting, by a selection device at the receiving party site, one of the sets of targeted data based on the targeting attributes and attributes of a receiving party of the receiving party site.

78. The method of claim 77, wherein the receiving party is a single user or a group of users.

79. An apparatus for providing targeted data, the apparatus comprising:
a receiver to receive, at at least one of a plurality of local broadcast sites, a broadcast stream carrying global data; and
an insertion section to insert, at said at least one of local broadcast sites, sets of targeted data associated with said at least one of local broadcast sites into the received broadcast stream, the sets of targeted data each associated with one of receiving parties serviced by the corresponding local broadcast site, whereby a modified broadcast stream carrying the global data and the sets of targeted data is generated at said at least one of local broadcast sites.

80. An apparatus for providing targeted data, the apparatus comprising:
a receiver to receive, at a receiving party site, a broadcast stream carrying global data and sets of targeted data, each of the sets of the targeted data carrying targeted content data having certain targeting attributes; and
a selection device at the receiving party site to select one of the sets of targeted data based on the targeting attributes and attributes of a receiving party of the receiving party site.

81. A system for providing targeted data, the system comprising:
a receiver to receive, at at least one of a plurality of local broadcast sites, a broadcast stream carrying global data;
an insertion section to insert, at said at least one of local broadcast sites, sets of targeted data associated with said at least one of local broadcast sites into the received broadcast stream, the sets of targeted data each associated with one of receiving parties serviced by the corresponding local broadcast site, whereby a modified broadcast stream carrying the global data and the sets of targeted data is generated at said at least one of local broadcast sites;
a receiver to receive, at a receiving party site, a broadcast stream carrying global data and sets of targeted data, each of the sets of the targeted data carrying targeted content data having certain targeting attributes; and
a selection device at the receiving party site to select one of the sets of targeted data based on the targeting attributes and attributes of a receiving party of the receiving party site.

82. A computer program product embodied on computer-readable media, for providing targeted data, the computer program product comprising computer-executable instructions for:
receiving, at at least one of a plurality of local broadcast sites, a broadcast stream carrying global data; and
inserting, at said at least one of local broadcast sites, sets of targeted data associated with said at least one of local broadcast sites into the received broadcast stream, the sets of targeted data each associated with one of receiving parties serviced by the corresponding local broadcast site, whereby a modified broadcast stream carrying the global data and the sets of targeted data is generated at said at least one of local broadcast sites.

83. The computer program product of claim 82, further comprising computer-executable instructions for:
receiving, at a receiving party site, the broadcast stream carrying the global data and the sets of targeted data, each of the sets of the targeted data carrying targeted content data having certain targeting attributes; and
selecting, by a selection device at the receiving party site, one of the sets of targeted data based on the targeting attributes and attributes of a receiving party of the receiving party site.
